(19) United States
(12) Patent Application Publication
(10) Pub. No.: US 2010/0209673 A1
(43) Pub. Date: Aug. 19, 2010

(54) PROCESS FOR TEXTURING THE SURFACE OF A SUBSTRATE HAVING A GLASS FUNCTION, AND GLASS PRODUCT HAVING A TEXTURED SURFACE

(75) Inventors: Emilie Viasnoff, Sevres (FR); Anne Durandeau, Paris (FR); Bernard Nghiem, Arsy (FR); Herve Montigaud, Neuilly Sur Marne (FR); David Le Bellac, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN GLASS FRANCE, Courbevoie (FR)

(21) Appl. No.: 12/669,806

(22) PCT Filed: Jul. 11, 2008
(86) PCT No.: PCT/FR2008/051308

§ 371 Date: Mar. 19, 2010

(30) Foreign Application Priority Data
Jul. 20, 2007 (FR) 0756649

(51) Int. Cl. C03C 15/00; B44C 1/22; C03C 17/00; B32B 3/30

(52) U.S. Cl. 428/172; 216/37

(57) ABSTRACT

Surface texturing process, i.e. one for the formation of at least one array of features with a characteristic dimension on at least one surface portion of a substrate having a glass function, characterized in that a solution containing at least one precursor of a material to be deposited is dissociated, at atmospheric pressure, within a flame, said flame being directed toward said surface portion so as to deposit, in the form of a plurality of nodules based on said material, a mask, said mask of said material being subjected to an etching step.

The present invention relates to the field of surface texturing and is intended in particular for a process of texturing the surface of a glass product, for a textured glass product and for its uses.

The texturing of materials is of considerable interest as it is applicable in many technological fields.

By creating an array of geometric features it is possible to give a material a new and novel function without changing its composition and its volume properties.

The writing of a periodically replicated feature has thus already been employed on glass products (either directly on the glass substrate or on a coating) in the case of millimeter-size features or even those of the order of one tenth of a millimeter in size, especially by lamination, laser etching or chemical etching techniques.

For features of smaller characteristic dimensions, especially with a width or period of micron or submicron size, the texturing techniques are in a great majority of cases lithographic techniques (optical lithography, electron lithography, etc.) which are used in microelectronics for producing integrated optic components.

However, these techniques are inappropriate in processes for manufacturing bulk glass products for one or more of the following reasons:
their high cost;
their slowness (scanning motion) and their complexity (comprising several steps);
the size of the features is limited (by the wavelength);
the small size of the structurable surfaces.

More recently, an alternative technology, usually called embossing, has been used to transfer elementary features, to be periodically replicated, from a mould to a soft coating deposited on a glass substrate.

This coating is textured by lowering a flat pressing die bearing the features to be replicated, these generally being “frozen-in” under UV or with heat.

Typically, the soft coating is a coating formed by the sol-gel process from inorganic precursors.

This method is used to manufacture components for the telecommunications field or, in quite another field, glasses having hydrophilic coatings. Thus, FR 2 792 628 teaches a hydrophobic glass obtained by molding a hydrophobized sol-gel product having reliefs (protrusions, craters or corrugations).

The advantages of this technique compared with the lithography processes are numerous.

In terms of cost, the same pressing die may be reused a large number of times and, starting from a single pattern, may give rise to a large number of replicas.

In terms of production rate, this is a single-step process, unlike the other lithographic techniques that require steps to reveal the features.

In terms of feature size, the size of the features on the pressing die is the main parameter that limits the size of the desired features, unlike in wavelength-limited optical lithography. In addition, it is very difficult using embossing techniques to obtain features having a size of less than 1 micron and an aspect ratio, defined as the ratio of the maximum depth to the maximum size of the features, of greater than 1.

This known technique of embossing using a flat pressing die is again unsatisfactory in terms of efficiency (manufacturing time, limitation in the number of operations) and its implementation is not satisfactory in the case of large, rigid and brittle, surfaces, such as for example glass surfaces.

Also known, from application WO 02/02472, is a method of nanotexturing a substrate having a glass function by means of a process using a mask formed from metal nodules around which the substrate is etched by a fluorinated plasma process.

The main drawback of this nanotexturing process lies in the fact that a single feature size scale can be obtained, that is to say the texture is made up of excrescences having only a certain size. The characteristic size of these excrescences is the same over the entire surface and therefore does not describe multiscale textures.

In addition, the implementation of this process involves a succession of separate steps—an alternation of vacuum deposition and etching steps—between which heating and cleaning steps at atmospheric pressure are carried out. This succession of steps at different pressures (under vacuum and at atmospheric pressure) is intrinsically costly and does not simplify industrial-scale production, namely on large substrates.

Thus, the subject of the present invention is an effective process for manufacturing a textured substrate having a glass function, said process being adapted to the industrial constraints of low cost and/or design simplicity and/or suitability for any size of area and size of feature.

The aim of this process is also to extend the range of textured substrates having a glass function that are available, in particular so as to obtain novel geometries of novel functionalities and/or applications.

For this purpose, the invention firstly provides a surface texturing process, i.e. one for the formation of at least one array of features with a characteristic dimension on at least one surface portion of a substrate having a glass function, characterized in that a solution containing at least one precursor of a material to be deposited is dissociated, at atmospheric pressure, within a flame, said flame being directed toward said surface portion so as to deposit, in the form of a plurality of nodules based on said material, a mask, said mask of said material being subjected to an etching step.

In preferred embodiments of the invention, one or more of the following arrangements may optionally be also provided:
the etching step is assisted by an atmospheric-pressure plasma;
the etching step is assisted by a vacuum plasma;
the surface portion of the substrate is preheated to a moderate temperature below 350° C., preferably below 300° C.;
the precursor of said material is injected in the form of a spray into the flame;
the mask of said material is deposited on a surface portion of a substrate precoated with at least one coating based on a second material;
the mask of said material is deposited on a surface portion of a bare substrate;
a relative movement is established between the substrate and the flame; and
the movement may be at a constant speed, so as to guarantee reproducibility, or with one or more variable speeds adjusted so as to obtain various texturings.

The invention will now be described in greater detail by means of nonlimiting examples and the figures, in which:

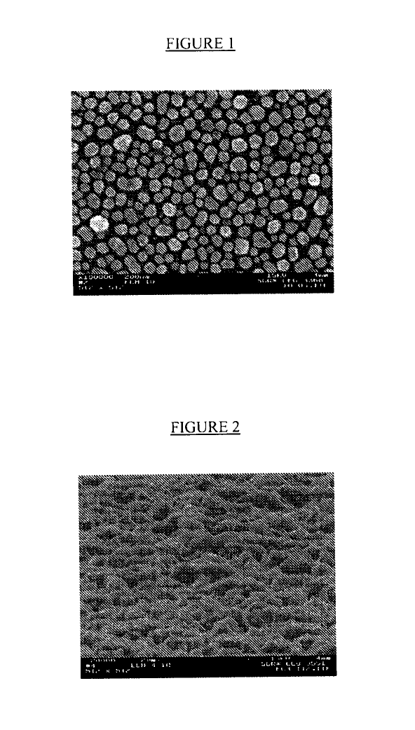

FIG. 1 is an SEM micrograph of a substrate coated with silver nodules deposited by a C-CVD technique;

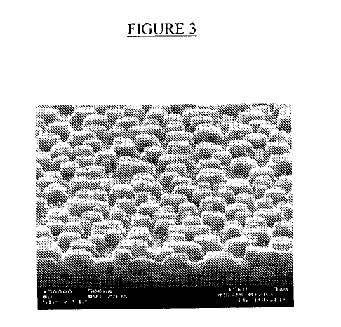

FIG. 2 is an SEM micrograph of a substrate coated with silver nodules deposited by a C-CVD technique, said substrate having undergone a functionalization step; and

FIG. 3 is an SEM micrograph of a substrate similar to that of FIG. 2, but in which the deposition and functionalization steps were carried out under vacuum.

The texturing process according to the invention can be easily automated and combined with other substrate conversion steps. The process also simplifies the production chain.

The process is suitable for the manufacture of large-volume and/or large-scale substrates, especially glass products for electronics or for the building or automotive industry, especially glazing.

Of course, the manufacturing parameters (substrate temperature, substrate/flame distance, pass speed, nature of the precursor, concentration of the precursor) are adjusted according to the nature of the substrate having a glass function, and more particularly according to the capability of the substrate to withstand the thermal and chemical stresses of the process, according to the desired aspect ratio of the features and/or according to the desired density of the features.

Within the context of the invention, the expression “substrate having a glass function” is understood to mean both a mineral glass (soda-lime-silica glass, borosilicate glass, glass-ceramic, etc.) and an organic glass (a thermoplastic polymer such as a polyurethane or a polycarbonate).

The substrate having a glass function is transparent, in particular with an overall light transmission of at least 70 to 75%.

The substrate having a glass function may also be a tinted glass or an absorbent glass.

As regards the composition of the substrate having a glass function, it is preferred to use a substrate having a linear absorption of less than 0.01 mm⁻¹ in that part of the spectrum useful for the application, generally the spectrum ranging from 380 to 1200 nm. It is also possible to use an extra-clear substrate, that is to say a substrate having a linear absorption of less than 0.008 mm⁻¹ in the spectrum having wavelengths ranging from 380 to 1200 nm. For example, a glass of the Diamant® brand sold by Saint-Gobain glass may be chosen.

The substrate having a glass function may be a monolithic, laminated or bicomponent substrate. After the texturing, the product may also undergo various glass conversion operations: toughening, shaping, lamination, etc.

The substrate may be thin, for example of the order of 0.1 mm in the case of mineral glasses or around 1 mm in the case of organic glasses, or thicker, for example with a thickness equal to or greater than a few mm or even cm.

Before its texturing according to the invention, the surface is not necessarily smooth and may have a form of texturing or may already be coated with at least one coating that is intended to undergo the texturing process. To give a nonlimiting example, this may be a coating of silica, a coating of titanium oxide, a coating of optionally doped tin oxide, of zinc oxide (whether doped or not), of oxinitrides or oxicarbides, (SiCO, SiON, etc.), a coating of the DLC (diamond-like carbon) family, etc.

This coating may form part of a multilayer stack on the glass substrate.

This coating may be a mineral, organic, especially polymeric or hybrid coating, filled with metal or oxide particles. This coating may also be of a glass nature and preferably transparent, and may be dense or be (meso)porous.

The discrete mask of nodules resulting from the dissociation of the precursor of the material within the flame may have several areas with features differing in their size (both width and height) and/or their orientation and/or their distance.

Preferably, the material of the mask is chosen from those exhibiting a dewetting property under the effect of heat. To a certain extent, the material constituting the mask has a surface energy such that it does not possess affinity with the material forming the substrate having a glass function. Thus, it may be a metal, used by itself or as an alloy, such as for example silver or gold or nickel, or an inorganic material or an organic material or a hybrid material or metal oxides.

Preferably, the material of the mask is chosen from those having a different, preferably lower, etching rate than that of the glass under the etching conditions chosen. If the etching rate of the material of the mask is higher than that of the glass, it is then necessary to choose a mask thickness such that the material remains right to the end of the etching of the glass-type substrate.

Depending on the intended texturing, this process need not necessarily result in perfect geometric shapes. In particular, features with sharp angles or features with rounded angles may be produced without impairing the required performance.

The texturing process according to the invention also makes it possible to achieve ever smaller characteristic feature magnitudes on ever larger surfaces, with an acceptable tolerance on texturing defects, i.e. one that does not impair the desired performance.

The manufacturing process makes the texturing of a brittle material possible and gives rise to novel geometries in large glass substrates.

In one advantageous embodiment, the characteristic dimension of the features, in particular their width, is less than 1 mm, preferably less than 100 microns and even more preferably less than 500 nm.

The texturing may advantageously be carried out continuously if an atmospheric-plasma-assisted etching process is used on a surface portion, whether curved or flat, of a substrate having a glass function with an area equal to or greater than 0.1 m², preferably equal to or greater than 0.5 m² and even more preferably equal to or greater than 5 m². In particular, the width of the product may be equal to or greater than 1 m.

However, there will be a break in the process in the case of vacuum plasma-assisted etching.

The texturing may be carried out directly on the substrate having a glass function (i.e. a “bare” substrate) or on a surface coating attached to the substrate, this coating thus being textured.

The thickness of this coating is advantageously equal to or greater than the maximum depth of the feature.

Even in this configuration of the invention, the substrate having a glass function remains essentially rigid.

The surface portion of the substrate having a glass function may be rendered deformable by local heating, especially using one or more lasers, or a plasma torch.

This substrate is mineral or organic, for example made of PMMA or PC (polycarbonate).

The process according to the invention may be integrated into a line for manufacturing the glass element and/or product, especially a mineral glass, for example it may be installed downstream of a float line, of a rolling line or horizontal stretching line, or downstream of a cathode sputtering deposition line (magnetron line), or in a subsequent operation.

To form the features after the mask has been deposited, the glass-type substrate covered with the material forming the etching mask is subjected to an etching step, by any etching process and preferably by a dry (particularly plasma-assisted, atmospheric-pressure or vacuum) etching technique.

The features resulting from this etching may be in the form of hollows and/or in the form of raised features, may be elongate, especially mutually parallel and/or at a constant distance apart (corrugations, zig-zags, etc.). The features may furthermore be inclined.

The texturing forms for example an array of protrusions, especially prismatic protrusions, and/or an array of elongate features, especially of rectangular, trianglular, trapezoidal, circular or irregular cross section.

The texture may be periodic, pseudo-periodic, quasi-periodic or random.

The surface may be textured several times, preferably continuously, it being possible for the features themselves to be textured.

For example, if the objective is to produce a superhydrophobic surface, the main features of conical or polygonal cross section may be textured by conical or polygonal (sub)features in order to enhance the hydrophobicity (Lotus effect).

The two main surfaces of said substrate having a glass function may be textured with similar or different features, whether simultaneously or in succession.

The process may also include a step of depositing a coating on the textured surface so as to functionalize the coating deposited. After said deposition step, this new textured coating may undergo a second texturing step, which may result in a new functionalization.

As a variant, the deposition of this coating on the textured surface may consist of the deposition of a plurality of superposed layers, at least one of the layers of which may be textured, thus giving the substrate having a glass substrate a functionalized multilayer stack.

The invention also covers a substrate having a glass function that can be obtained by the process as described above.

This substrate having a glass function has all the abovementioned advantages (low production cost, feature homogeneity, etc.).

At least one of the characteristic dimensions, especially the width of the features, is preferably less than 1 mm, more preferably less than 100 μm and even more preferably less than 500 nm, and the array preferably extends over an area greater than 0.1 m², even more preferably equal to or greater than 0.5 m².

The textured glass product may be intended for an application in electronics or in a building or automobile. In particular, mention may be made of products, especially glazing products, for flat screens (with reflective polarizer and transparent electrodes), products for buildings and automobiles, products for illumination (lightguides), and products having modified wetting properties (superhydrophobic and superhydrophilic products).

The array may be a 3D array or, more specifically a 2D array, one of the characteristics dimensions of the features being almost invariant in a preferential direction of the surface.

The surface on the opposite side to the flat surface may also be textured and/or covered with a functional coating. Comment: in the case of float glass, the atmospheric side or the tin side may be textured.

The function and the properties associated with the texturing depend on the following characteristic dimensions:
the height h of the features (maximum height in the case of a plurality of heights) and the width w of the features (maximum width in the case of a plurality of widths), especially the h/w ratio; and
the distance d (maximum distance in the case of a plurality of distances) between features and in particular the w/d ratio, or the pitch p, i.e. the sum w+d.

In the present invention, it is preferable:
for the distance d to be between 10 nm and 1 mm, preferably between 10 and 500 nm;
for the width w to be between 10 nm and 1 mm, preferably 10 nm and 10 μm; and
for the h/w ratio, in other words the aspect ratio, to be equal to or less than 10.

One, some or all of the characteristic dimensions may preferably be of micron or submicron size, or even of nanometer size.

The surface texturing may induce physico-chemical modifications, especially surface energy modifications.

To modify the wetting, features ranging in size down to 1 micron are possible.

Other details and advantageous characteristics of the invention will become apparent on reading the examples.

### EXAMPLE 1

Production of Ag nodules by combustion CVD (CCVD):
susceptor temperature: 80° C.
number of passes beneath the nozzle: 10
flame/specimen distance: 10 mm
precursor: aqueous silver nitrate solution
precursor concentration: 0.5 mol/l
nebulizing N₂ flow rate: 1.7 slpm
diluting N₂ flow rate: 13.6 slpm.

Nanometer-sized nodules were therefore obtained, these having a diameter of between 20 nm and 200 nm and being distributed uniformly over the surface. The reader may refer to FIG. 1.

### EXAMPLE 2

Treatment of a glass surface covered with silver nodules deposited by a CCVD technique and treated with an atmospheric-pressure fluorinated plasma (the reader may refer to FIG. 2).

Atomflow© source sold by SurfX Technologies (5 cm diameter) based on a capacitive discharge generated in helium, blown toward the substrate, which was underneath (in “remote” or in “post-discharge” mode). The gas passed through two pierced aluminum electrodes spaced apart by a few millimeters. The gas was excited by an RF (radiofrequency) signal at 13.56 MHz applied to one of the electrodes (the other being grounded).

An HE (90 slpm/O₂ (1 slpm)/CF₄ (1 slpm) mixture was used.

The textures obtained after etching the silver nodule mask were protrusions ranging in size from a few nanometers to a few tens of nanometers, spaced apart by a distance ranging from a few nanometers to a few tens of nanometers, and with a maximum aspect ratio of 1.

The textured substrate was then functionalized by a hydrophobic solution (FAST-type perfluorated molecule) applied by being wiped on so as to obtain a superhydrobic effect.

By choosing the suitable etching conditions, it was possible to obtain superhydrobic specimens (water contact angle=138° with a moderate haze. The contact angle for the same specimen without nanotexturing was only 110°.

### EXAMPLE 3

### The Reader May Refer to FIG. 3

A sheet of clear float glass 0.7 mm in thickness sold under the brand name “Planilux” by Saint-Gobain Glass France was provided with a coating of ITO (tin-doped indium oxide) 110 nm in thickness using any deposition technique known for this purpose, followed by an SiO₂ film 100 nm in thickness by any suitable technique (plasma-enhanced magnetron sputtering, pyrolysis, plasma-enhanced CVD, sol-gel, etc.).

An Ag film 15 nm in thickness was vacuum deposited by magnetron sputtering. This Ag film was then subjected to a dewetting process by heat treatment at 300° C. under a vacuum of 9 mTorr for 30 min. Ag nodules were thus formed on the SiO₂ film.

The substrate thus obtained was subjected to reactive ion etching under the following operating conditions.

The cathode was supplied with DC current, the ITO conductive sublayer being biased, by being connected to a radiofrequency generator set at 13.56 MHz. SF₆ was used as plasma gas at a pressure of 75 mTorr. The power was 0.106 W/cm² and the treatment duration was 250 s.

Immersion overnight in a 1M aqueous HNO₃ solution at room temperature had the effect of removing that fraction of the Ag nodules that were not etched in the previous etching step.

The substrate obtained, seen at an angle of 15° with a magnification of 50 000 under a scanning electron microscope is shown in the appended FIG. 3. What is observed is a formation of excrescences, at least 80% of which have heights between 70 and 200 nm, with mean diameters between 50 and 400 nm, at least 80% of the distances between neighboring excrescences being between 1 and 500 nm. These excrescences may be defined as right truncated cones having axes perpendicular to the main plane of the substrate and with small apex half-angles, of less than 20°.

A perfluorooctylethyltrichlorosilane (C₁₀F₁₇H₄SiCl₃) monolayer was vapor-grafted under vacuum onto this substrate.

The advancing angle and the receiving angle, measured by increasing and decreasing the volume of a water droplet respectively by means of a pipette, were 165° and 122° respectively, corresponding to superhydrophobic behavior.

In addition, a light transmission of 92.8% and a haze of less than 4% were measured by means of a Hazeguard XL 211 apparatus.

1. A surface texturing process for the formation of at least one array of features with a characteristic dimension on at least one surface portion of a substrate having a glass function, wherein a solution containing at least one precursor of a material to be deposited is dissociated, at atmospheric pressure, within a flame, said flame being directed toward said surface portion so as to deposit a mask, in the form of a plurality of nodules based on said material, said mask of said material being subjected to an etching step.

2. The texturing process as claimed in claim 1, wherein the etching step is assisted by an atmospheric-pressure plasma.

3. The texturing process as claimed in claim 1, wherein the etching step is assisted by a vacuum etching technique or a plasma etching technique.

4. The texturing process as claimed in claim 1, wherein the surface portion of the substrate is preheated to a moderate temperature below 350° C.

5. The texturing process as claimed in claim 1, wherein the precursor of said material is injected in the form of a spray into the flame.

6. The texturing process as claimed in claim 1, wherein the mask of said material is deposited on a surface portion of a substrate precoated with at least one coating based on a second material.

7. The texturing process as claimed in claim 1, wherein the mask of said material is deposited on a surface portion of a bare substrate.

8. The texturing process as claimed in claim 1, wherein a relative movement is established between the substrate and the flame.

9. The texturing process as claimed in claim 8, wherein the movement may be at a constant speed, so as to guarantee reproducibility, or with one or more variable speeds adjusted so as to obtain various structurings.

10. The texturing process as claimed in claim 1, wherein at least one of the characteristic dimensions of the features is less than 1 mm.

11. The texturing process as claimed in claim 1, wherein the texturing forms an array of projections and/or an array of elongate features, the features being optionally inclined.

12. A substrate having a glass function, which is obtained by the method as claimed in claim 1.

13. The substrate having a glass function as claimed in claim 12, wherein one of the characteristic dimensions (w) is of micron or submicron size.

14. The substrate having a glass function as claimed in claim 12, wherein each feature is defined by a height h, a width w and a distance d, the distance d being chosen between 10 nm and 1 mm and the aspect ratio h/w being chosen to be equal to or less than 10.

15. The substrate having a glass function as claimed in claim 12, wherein it is intended to be used in buildings or in automobiles, or is hydrophobic or hydrophilic glazing.
